(19) United States
(12) Patent Application Publication
(10) Pub. No.: US 2015/0009143 A1
(43) Pub. Date: Jan. 8, 2015

(54) OPERATING SYSTEM

(71) Applicant: Funai Electric Co., Ltd., Osaka (JP)

(72) Inventor: Yasuo MASAKI, Daito-shi (JP)

(21) Appl. No.: 14/321,960

(22) Filed: Jul. 2, 2014

(30) Foreign Application Priority Data
Jul. 8, 2013 (JP) 2013-142730

(51) Int. Cl. G06F 3/0354; G06F 3/041

(52) U.S. Cl. CPC G06F 3/03547; G06F 3/041; G06F 2203/04108
USPC 345/158; 345/173

(57) ABSTRACT

An operating system includes a coordinate information generating unit configured to, when a touch on a touch panel is detected, deem that a virtual hovering operation that is performed virtually in air above the touch panel surface was performed and shift to a hovering operation mode that generates two-dimensional coordinate information indicating the touched position and height position information having a positive value, and then, when a particular operation is received during the virtual hovering operation, deem that a virtual touch operation was performed and generate two-dimensional coordinates indicating the touched position and height position information with a value of zero, a display control unit configured and programmed to display on a display unit a specified hovering cursor at the display position that corresponds to the two-dimensional position of the virtual hovering operation so as to be superimposed on key images, and a function information output unit configured to output, when the virtual touch operation is performed, function information assigned to the corresponding key.

### BACKGROUND OF THE INVENTION

1. Field of the Invention

The present invention relates to an operating system that uses a touch panel.

2. Description of the Related Art

On conventional touchpad-style user interface devices, a pointing cursor displayed in a superimposed manner on the display device is generally moved by touch operations with a fingertip to select objects within the display screen of the display device (link information, button functionality, and the like), thereby executing functions.

However, with such virtual pointing cursor operations as described above, although it was possible to execute direct operations on objects displayed on-screen, it was not possible to realize an interface like that of the key operations of a conventional remote control device.

Furthermore, Japanese Patent Application Laid-Open Publication No. 2010-61224 discloses an automotive input/output device equipped with a touchpad and a display that is installed in a location relatively more remote than this touchpad. With this conventional automotive input/output device, the shade, size, and the like of the cursor displayed on the display are changed according to the distance between the touchpad and the operating finger, and based on absolute coordinate information that is input by touchpad operations, the cursor is displayed in a position corresponding to the absolute coordinate information.

With Japanese Patent Application Laid-Open Publication No. 2010-61224, the user can operate the cursor while looking at the display without looking at the touchpad in hand. Smart phones and the like generally integrate the touch panel and display, so the user can perform operations by means of the touch panel while looking at the display. In Japanese Patent Application Laid-Open Publication No. 2010-61224, the touchpad and display are disposed apart from each other, so it can be the that a virtual touchscreen display is realized.

However, even Japanese Patent Application Laid-Open Publication No. 2010-61224 does not achieve an interface like that of key operations by a conventional remote control device.

Note that there have conventionally been remote control devices with learning functions that have both touch panels and liquid crystal display units; in such a remote control device, keys are displayed on the display screen on the side of the remote control device, and key operations are realized by touch operations that involve touching these positions. With such a remote control device, however, the user was required to perform operations while viewing the display unit on the remote control device in hand, so the virtual touchscreen display was not realized.

### SUMMARY OF THE INVENTION

In light of the circumstances, preferred embodiments of the present invention provide an operating system that realizes a virtual touchscreen display with which the feel of operating using a conventional remote control device is obtained.

An operating system according to a preferred embodiment of the present invention includes a touch panel; a coordinate information generating unit configured to, when a touch on the touch panel is detected, deem that a virtual hovering operation that is performed virtually in air above the touch panel surface of the touch panel was performed and to shift to a hovering operation mode that generates two-dimensional coordinate information indicating the touched position on the touch panel and height position information having a positive value, and then, when a particular operation is received during the virtual hovering operation, deem that a virtual touch operation was performed and generate two-dimensional coordinates indicating the touched position on the touch panel and height position information having a value of zero; a display control unit programmed and configured to display on a display unit a specified hovering cursor at the display position that corresponds to the two-dimensional position of the virtual hovering operation so as to be superimposed on key images for remote operation; and a function information output unit configured to output, when the virtual touch operation is performed, function information assigned to the key that corresponds to the two-dimensional position of the virtual touch operation.

With such a configuration, the coordinate information generating unit is configured to shift to a hovering operation mode when a user touches the touch panel, and a hovering cursor is displayed so as to be superimposed on key images in keeping with a virtual hovering operation that is performed by actually touching the touch panel. Then, when a particular operation is performed during the virtual hovering operation, function information is output as though the touch panel were touched from the virtually hovering state. Based on the output of function information, the corresponding function is activated.

The user performs a hovering operation to operate the hovering cursor without looking at the touch panel in hand but instead viewing the key images and hovering cursor displayed in a superimposed manner on a display unit located away from the touch panel, and function information assigned to the key at which the hovering cursor is positioned is output when a particular operation is performed. A virtual touchscreen display is therefore realized which makes it possible for the user to obtain the feel of operating using a conventional remote control device.

Moreover, because the hovering operation is performed by touching the touch panel, a particular operation is reliably performed with the hovering cursor at the desired position, and the desired function is reliably activated by the output of function information.

In addition, the display control unit may also be configured so as to change the display from the hovering cursor to a specified touch cursor when the virtual touch operation is performed.

By adopting such a configuration, the user can easily ascertain from the change in the display from a hovering cursor to a touch cursor that function information was output by the touch operation.

Furthermore, the display control unit may also be configured so as to cancel the display of the key images and the touch cursor when the touch of the touch panel is released following the particular operation.

Moreover, the display control unit may also be configured so as to cancel the display of the key images and the hovering cursor when the touch of the touch panel is released during the virtual hovering operation.

In addition, the particular operation may also be at least one operation from among a touch operation that continues for a set period of time at a single position on the touch panel, a press operation on a specified operating key, a serial operation of a second touch after touch is released within a set period of time after the touch operation has continued at a single position on the touch panel, and a touch operation by an operating object that is different from that for the touch to enter the hovering operation mode.

Furthermore, an operating system according to another preferred embodiment of the present invention includes a touch panel; a display control unit programmed and configured to display on a display unit a specified hovering cursor at the display position that corresponds to the two-dimensional position of a hovering operation that is performed actually in air above the touch panel surface of the touch panel so as to be superimposed on key images for remote operation; and a function information output unit configured to output, when the hovering operation is switched to a touch operation that touches the touch panel, function information for the key that corresponds to the two-dimensional position of the touch operation.

With such a configuration, the user manipulates the hovering cursor that is displayed so as to be superimposed on the key images by performing an actual hovering operation that is performed actually in the air above the touch panel surface and then actually touches the touch panel during the actual hovering operation, thus outputting function information of the key that is positioned at the hovering cursor. Accordingly, it is possible to realize a virtual touchscreen display with which the feel of operating using a conventional remote control device is obtained. Moreover, with this configuration, operability that is more sensory-based for the user is realized.

In addition, this operating system preferably further includes an operating device which includes the touch panel and a detecting unit configured to detect the inclination of the grip attitude of the operating device or movement that accompanies its inclination, and the display control unit preferably is also be configured so as to change the display position of the key images according to the detection results from the detecting unit.

Such a configuration makes it possible to move the key images to a desired position via sensory-based operations and therefore to prevent the key images from impeding the visibility of underlying images.

Furthermore, the display control unit may also be configured so as to change the display position of the key images according to the two-dimensional position of the operating object on the touch panel surface when the mode shifts to the hovering operation.

By using such a configuration, the key images are displayed at a desired position based on the position of the operating object when the mode shifts to the hovering operation, so the key images are prevented from impeding the visibility of underlying images.

Moreover, this operating system preferably further includes a judgment unit configured to make a judgment that a phase that requires key input has entered, and is preferably also configured so as to automatically shift into a key input mode which enables superimposed display control of the key images and the hovering cursor when there is a judgment by the judgment unit.

Various preferred embodiments of the present invention makes it possible to realize a virtual touchscreen display with which the feel of operating using a conventional remote control device is obtained.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram showing the overall system configuration according to a preferred embodiment of the present invention.

FIG. 2 is a block configuration diagram of the operating device according to a preferred embodiment of the present invention.

FIG. 3 is a block configuration diagram of the processing device according to a preferred embodiment of the present invention.

FIG. 4 is a block configuration diagram of the television according to a preferred embodiment of the present invention.

FIG. 5 is a flowchart pertaining to the action of three-dimensional coordinate output by the operating device according to a preferred embodiment of the present invention.

FIG. 6 is a flowchart pertaining to the control action of the processing device according to a preferred embodiment of the present invention.

FIG. 7 is a diagram showing the superimposed display of key images and a hovering cursor according to a preferred embodiment of the present invention.

FIG. 8 is a diagram showing the superimposed display of key images and a touch cursor according to a preferred embodiment of the present invention.

FIG. 9 is a diagram showing a state of operation by a finger in the entire system according to a preferred embodiment of the present invention.

### DETAILED DESCRIPTION OF THE PREFERRED EMBODIMENTS

### First Preferred Embodiment

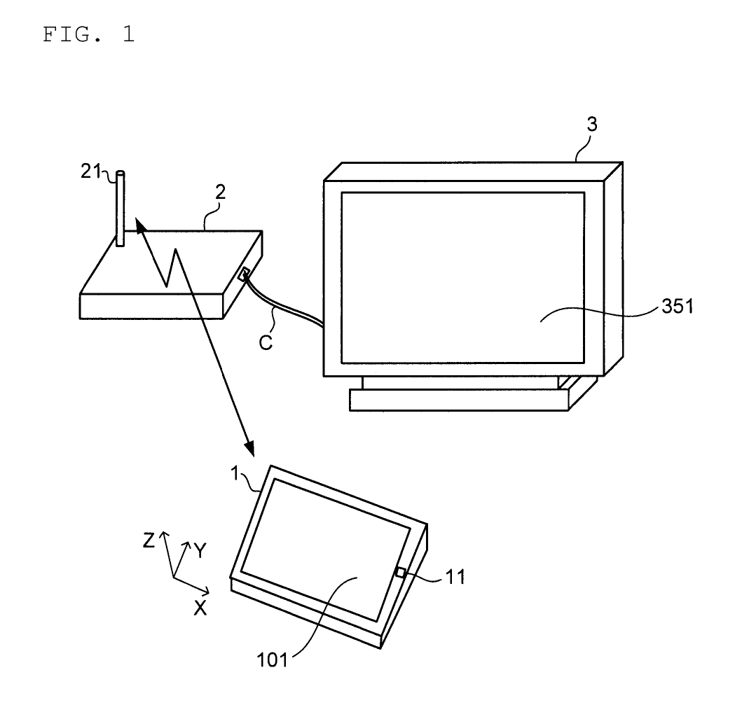

Preferred embodiments of the present invention will be described below with reference to drawings. FIG. 1 shows a system configuration including an operating system and television according to a first preferred embodiment of the present invention. The system shown in FIG. 1 preferably includes a television 3 and an operating system including an operating device 1 equipped with a touch panel 101 and a processing device 2. With the system shown in FIG. 1, a user operates the touch panel 101 of the operating device 1 while looking at the display screen 351 of the television 3, thus making it possible to realize a virtual touchscreen display.

Besides the touch panel 101, the operating device 1 is equipped with an operating key 11 which will be described later. The operating device 1 preferably performs processing compliant with Android (registered trademark), for example, which is one platform.

The television 3 has the display screen 351 as described above. The processing device 2 sends and receives specified information to and from the operating device 1 by performing wireless communications compliant with Bluetooth (registered trademark), for example, which is a short-distance wireless communications standard.

Furthermore, the processing device 2 is connected to the television 3 through an HDMI (high-definition multimedia interface; registered trademark) cable C and provides specified image information to the television 3. Note that it is also possible to have the processing device 2 and the television 3 be capable of wireless communications. Moreover, in the present preferred embodiment, the operating device 1 and the processing device 2 are preferably provided separately, but the present invention is not limited to this example; a singular device that is configured to provide the functions of both the operating device 1 and the processing device 2 may be used.

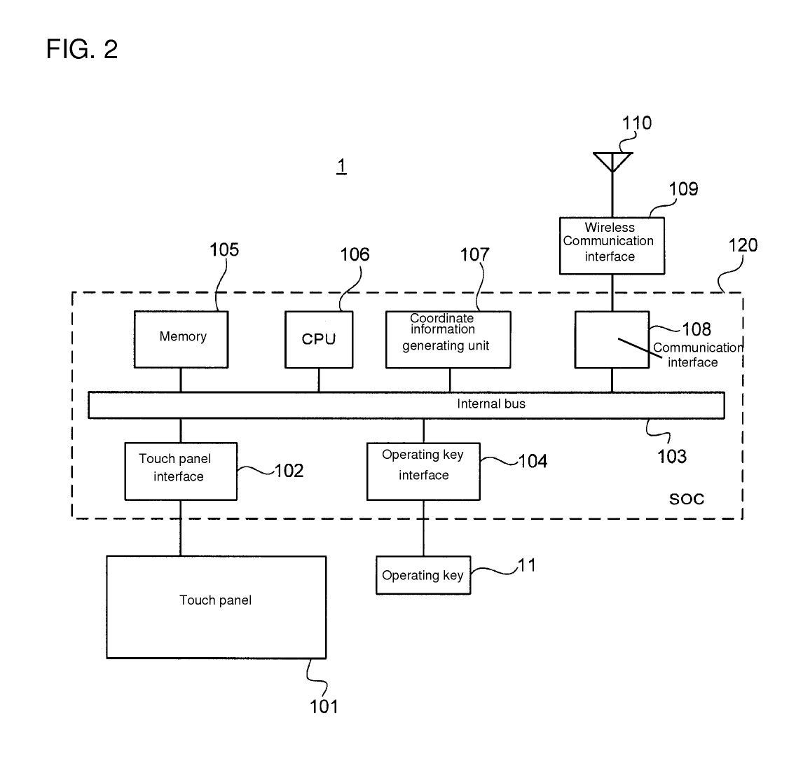

FIG. 2 shows a block configuration diagram of the operating device 1 according to the present preferred embodiment. The operating device 1 preferably includes a system-on-chip (SOC) 120, the touch panel 101, the operating key 11, a wireless communication interface 109, and an antenna 110 as shown in FIG. 2.

The touch panel 101 is a touch panel of a capacitive system, for example, and detects the two-dimensional position (the X, Y coordinate position shown in FIG. 1) touched by an operating object such as a finger. Note that the touch panel 101 itself detects two-dimensional positions, but as will be described later, the operating device 1 has as its role to add height position information as well in the direction perpendicular to the virtual touch panel surface (the Z coordinate position shown in FIG. 1) to the two-dimensional coordinate information and to output the resulting information.

On the SOC 120, the following constituent elements are connected to an internal bus 103. The SOC 120 is equipped with a touch panel interface 102, an operating key interface 104, a memory 105, a central processing unit (CPU) 106, a coordinate information generating unit 107, and a communication interface 108.

The touch panel interface 102 is an interface configured to connect the touch panel 101 to the SOC 120.

The operating key interface 104 is an interface configured to connect the operating key 11 to the SOC 120. The operating key interface 104 receives information which indicates the operation of the operating key 11 (for example, information which indicates the ON period for a signal) and outputs this information to the CPU 106.

The memory 105 is a storage medium is configured to store various control programs required for the actions of the operating device 1. The memory 105 preferably is preinstalled with a program that constitutes the Android (registered trademark) as one of its control programs.

The CPU 106 is configured to perform functions as a control unit through the operation of a control program stored in the memory 105, such as Android (registered trademark).

The communication interface 108 is an interface configured to connect the wireless communication interface 109 to the SOC 120.

The coordinate information generating unit 107 is configured to generate and output, in addition to the two-dimensional coordinate information of the touched position detected by the touch panel 101, virtual height position information as will be described later.

The operating key 11 is an operating key configured to perform particular operations to be described later. Note that the operating key 11 is not required for some definitions of particular operations.

The wireless communication interface 109 is an interface for the SOC 120 to perform wireless communications with the processing device 2 through the antenna 110.

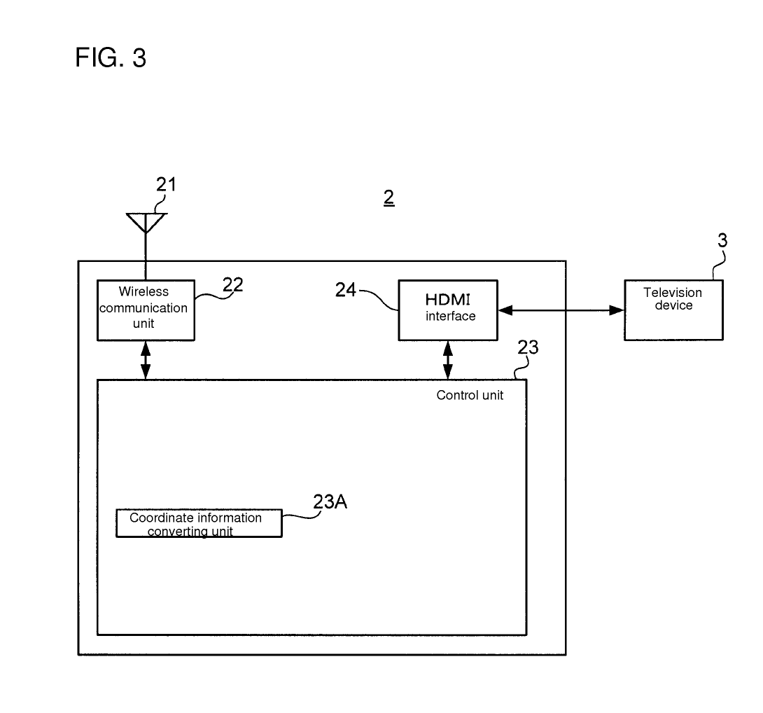

Next, FIG. 3 shows a block configuration of the processing device 2 according to the present preferred embodiment. The processing device 2 preferably includes an antenna 21, a wireless communication unit 22, a control unit 23, and an HDMI interface 24 as shown in FIG. 3.

The wireless communication unit 22 is configured to send and receive various types of information wirelessly to and from the operating device 1 via the antenna 21.

The control unit 23 preferably includes a CPU and a memory in which Android (registered trademark), for example, is stored in advance, and is configured and programmed to control the processing device 2.

In addition, the control unit 23 preferably is configured and programmed to include a coordinate information converting unit 23A as a functional unit; this functional unit is realized by software. The coordinate information converting unit 23A will be described later.

The HDMI interface 24 is configured to enable the control unit 23 to send and receive various types of information such as a variety of image information to and from the television 3 over the HDMI cable C (FIG. 1) in compliant with the HDMI standard.

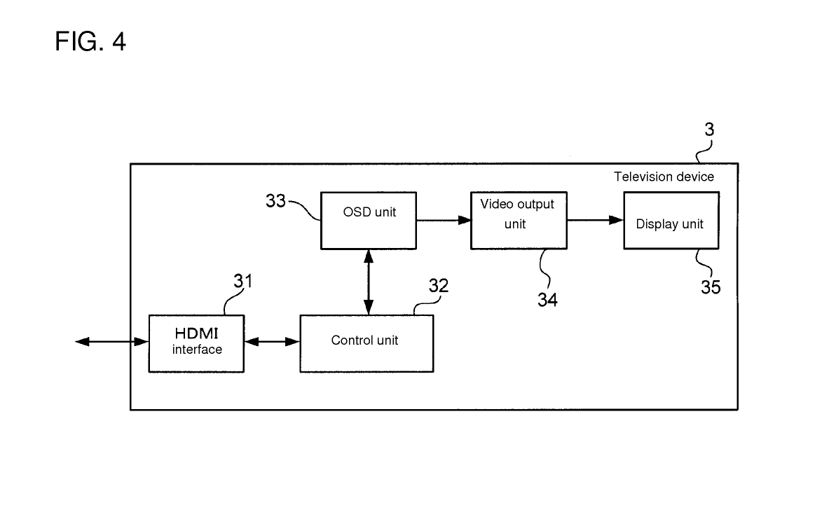

Next, FIG. 4 shows a block configuration of the television 3 according to the present preferred embodiment. The television 3 preferably includes an HDMI interface 31, a control unit 32, an on-screen display (OSD) unit 33, a video output unit 34, and a display unit 35 as shown in FIG. 4.

Note that the television 3 naturally has a constitution pertaining to broadcast reception such as a tuner and a constitution pertaining to audio output, but these are omitted from illustration in FIG. 4.

The HDMI interface 31 is configured to send and receive various types of information such as image information to and from the HDMI interface 24 (FIG. 3) with which the processing unit 2 is equipped.

The control unit 32 is a control device that is configured and programmed to control the television 3. The control unit 32 preferably is configured of a microcomputer, for example.

The OSD unit 33 is configured to generate display data for the onscreen display upon orders from the control unit 32. The OSD unit 33 generates, for example, display data of menu screens, key display images (described later), cursor images, and the like.

The video output unit 34 is configured to convert display data that is input from the OSD unit 33 into video signals suited to the display unit 35 and output them to the display unit 35. Note that the video output unit 34 also is configured to superimpose video from broadcast reception and on-screen display video.

The display unit 35 is configured of a liquid crystal display unit, for example, and includes the display screen 351 (FIG. 1). The display unit 35 displays video on the display screen 351 based on the video signal that is input from the video output unit 34.

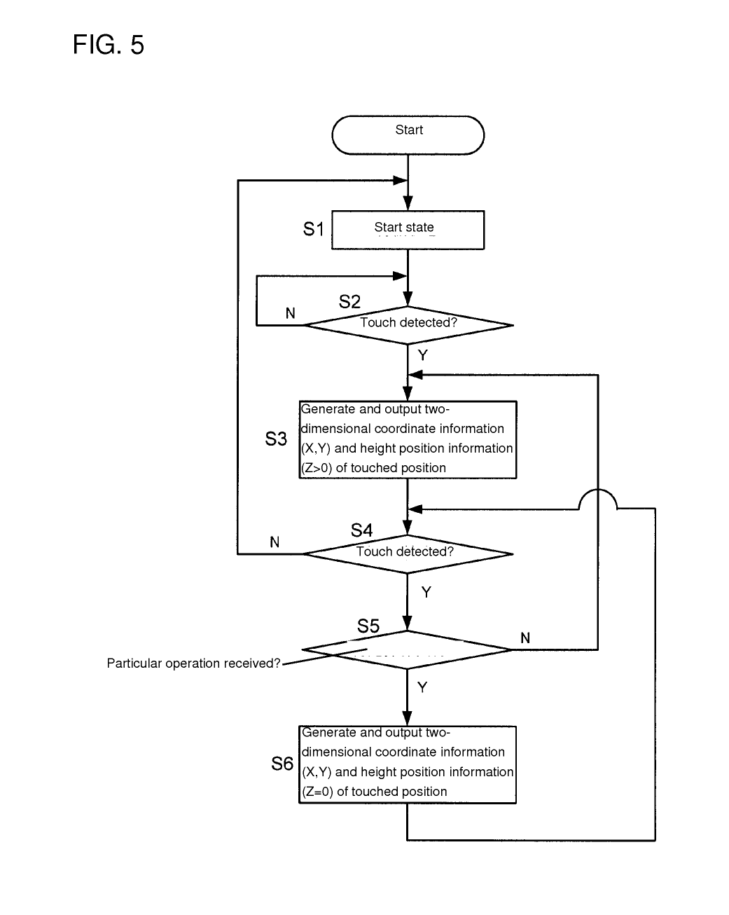

Next, the action of three-dimensional coordinate output by the operating device 1 will be described with reference to the flowchart shown in FIG. 5.

When the flowchart shown in FIG. 5 starts, the coordinate information generating unit 107 of the operating device 1 is placed in a standby state in step S1. Furthermore, it remains in standby as long as the touch panel 101 does not detect any touch on the touch panel surface (N in step S2).

When the touch panel 101 detects a touch on the touch panel surface in step S2 (Y in step S2), the procedure advances to step S3, and the coordinate information generating unit 107 generates the two-dimensional coordinate information (X, Y) and height position information (Z>0, i.e., Z is a specified positive value) of the touched position and outputs it to the processing device 2 through the wireless communication interface 109 and the antenna 110.

After step S3, if the touch panel 101 does not detect a touch on the touch panel surface in step S4 (N in step S4), the procedure returns to step S1, and the coordinate information generating unit 107 returns to standby. On the other hand, if the touch panel 101 detects a touch on the touch panel surface in step S4 (Y in step S4), the procedure advances to step S5.

In step S5, if a particular operation is not received (N in step S5), the procedure returns to step S3, and the coordinate information generating unit 107 generates two-dimensional coordinate information and height position information that has a positive value for the touched position and outputs it.

Here, the particular operation refers to the following four operations, for examples:

(1) A touch operation that continues for a set period of time at a single position on the touch panel 101

(2) An operation that presses the operating key 11

(3) A serial operation in which a touch operation continues at a single position on the touch panel 101, and the touch is then released within a set period time, after which a touch is performed again

(4) A touch operation by an operating object (finger or the like) that is different from that for the touch detected in step S2

If any one of the four particular operations described above is received in step S5 (Y in step S5), the procedure advances to step S6. Note that the particular operation may be defined as at least any one of the four operations. For example, only one operation among the four operations may be defined as the particular operation. Furthermore, if the operation (2) described above is not defined as a particular operation, it is also possible to have a configuration in which the operating key 11 is not provided.

In step S6, the coordinate information generating unit 107 generates the two-dimensional coordinate information (X, Y) and height position information that has a value of 0 (Z=0) of the touched position and outputs it to the processing device 2 via the wireless communication interface 109 and the antenna 110. Then, the procedure returns to step S4.

The above is the procedure for the flowchart shown in FIG. 5. After a touch is detected in step S2, the two-dimensional coordinates and the height position information that has a positive value for the touched position are output in step S3 for as long as the touch operation is one other than a particular operation. Even though a touch operation is actually performed on the touch panel surface of the touch panel 101, three-dimensional coordinates that include height position information having a positive value are output, as though the operation were performed virtually in the air above the touch panel surface, i.e., as though a virtual hovering operation were performed. Accordingly, when a touch is detected in step S2, the mode shifts to the hovering operation mode.

If a particular operation is performed during this sort of virtual hovering operation, then height position information with a value of 0 is output together with the two-dimensional coordinates of the touched position in step S6. Three-dimensional coordinates that include height position information with a value of 0 are output, deeming that an operation which touches the touch panel surface, i.e., a virtual touch operation, was performed from the state in which an operation was performed virtually in the air over the touch panel surface.

Note that if a touch operation other than a particular operation is performed after step S6 (N in step S5), the procedure returns to step S3, and the mode shifts to the hovering operation mode. Moreover, if the touch operation is released after step S6 (N in step S4), the procedure returns to step S1 and goes into standby.

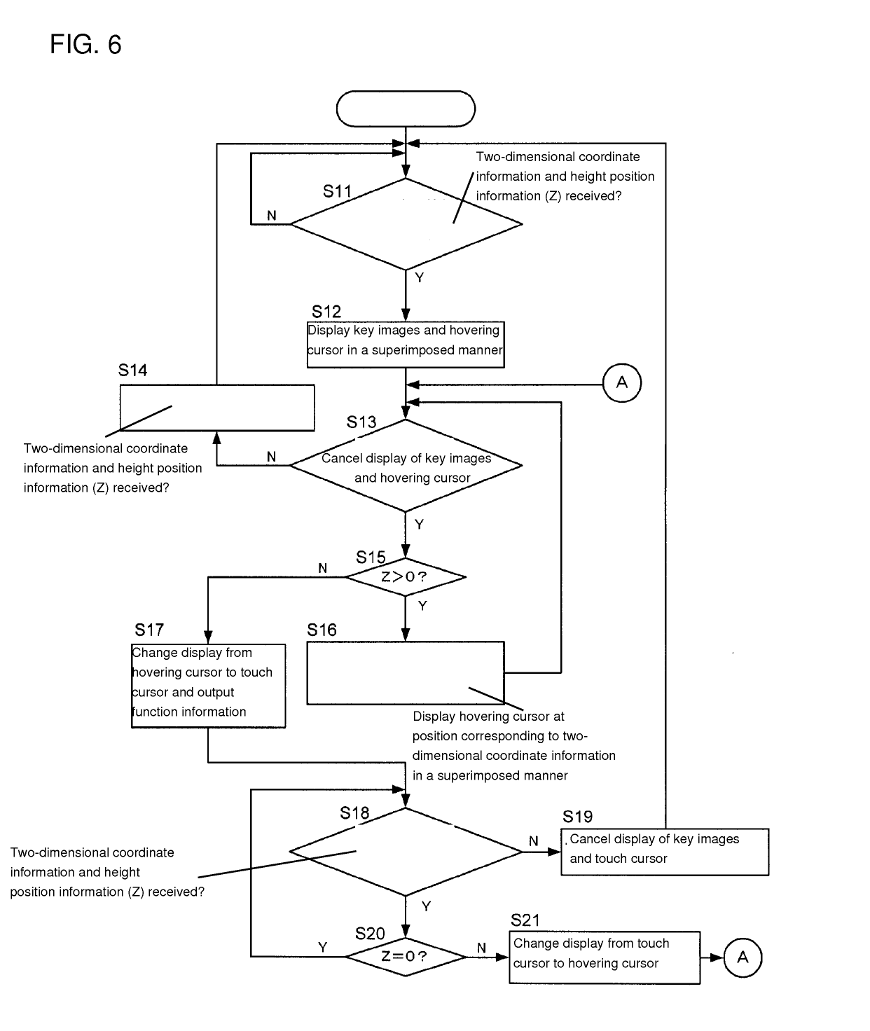

Next, the control action of the processing device 2 in conjunction with the action of three-dimensional coordinate output of the operating device 1 will be described with reference to the flowchart shown in FIG. 6.

When the procedure in the flowchart shown in FIG. 6 begins, the control unit 23 of the processing device 2 monitors in step S11 whether three-dimensional coordinate information (two-dimensional coordinate information plus height position information) has been received from the operating device 1 via the antenna 21 and the wireless communication unit 22. If it has received it (Y in step S 11), the procedure advances to step S12.

In step S12, the control unit 23 sends key image information to display the images of the keys of a remote control device and coordinate information that indicates the specified positions at which the key images are to be displayed on the television 3 (display unit 35) to the television 3 over the HDMI interface 24. Together with this, the control unit 23 also sends hovering cursor image information to display a hovering cursor and coordinate information that indicates the specified position at which the hovering cursor is to be displayed on the television 3 to the television 3 over the HDMI interface 24. As a result, the hovering cursor is displayed so as to be superimposed on the key images at the specified position on the display unit 35 of the television 3.

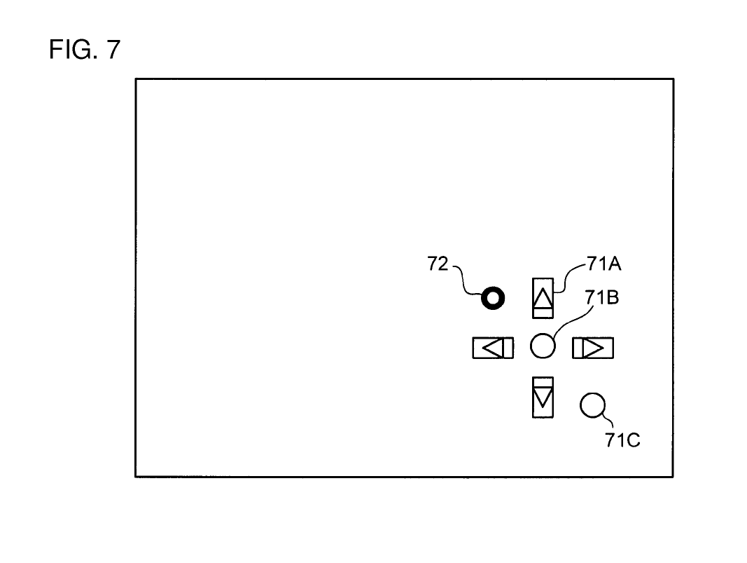

FIG. 7 shows one example of superimposed display of key images and a hovering cursor. In the example of FIG. 7, key images 71A, 71B, and 71C and a hovering cursor 72 are displayed in a superimposed manner. The key image 71A represents a cross-shaped up/down/left/right key, the key image 71B represents a select key, and the key image 71C represents a “Back” key (a key for returning to the previous screen or the like). In addition, the key images and the hovering cursor are displayed in a superimposed manner on a basic screen such as a menu screen.

Note that the key images are not limited to the example of FIG. 7, and a variety of keys such as volume keys and channel keys may also be included.

When the control unit 23 receives three-dimensional coordinate information in step S13 from the operating device 1 after step S12 (Y in step S13), the procedure advances to step S15, and the control unit 23 determines whether or not the height position information it received has a positive value (Z>0). If it has a positive value (Y in step S15), the procedure advances to step S16, and the control unit 23 uses the coordinate information converting unit 23A to convert the received two-dimensional coordinates (X, Y) into the coordinates of a display position on the display unit 35 of the television 3 and transmits the converted coordinate information to the television 3 over the HDMI interface 24. The hovering cursor is thus displayed on the display unit 35 at the position of the transmitted coordinate information. Then, the procedure returns to step S13.

Note that if three-dimensional coordinate information is not received in step S13 (N in step S13), the procedure advances to step S14, and the control unit 23 cancels the display of the key images and hovering cursor on the display unit 35 by sending a control signal over the HDMI interface 24 to the television 3.

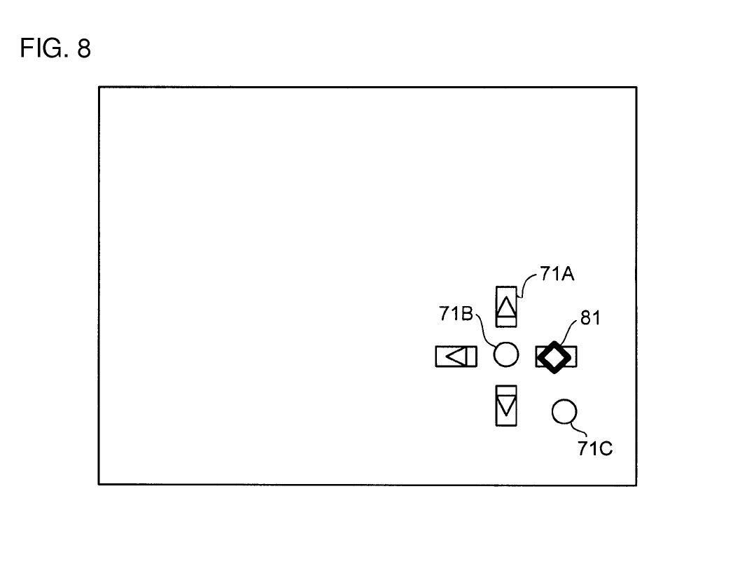

In addition, if the height position information received is 0 in step S15 (N in step S15), then the procedure advances to step S17, and the control unit 23 transmits touch cursor image information for displaying a touch cursor to the television 3 over the HDMI interface 24 and changes the display of the hovering cursor on the display unit 35 to a touch cursor display. FIG. 8 shows an example of a touch cursor display. In FIG. 8, a touch cursor 81 is displayed. The touch cursor has a different shape, color, and so on from the hovering cursor.

Together with this, the control unit 23 converts the two-dimensional coordinates received in step S13 into the coordinates of a display position on the display unit 35 using the coordinate information converting unit 23A and transmits the function information corresponding to the key at the converted coordinate position to the television 3 over the HDMI interface 24 (if there is no corresponding function information, no function information is output). In HDMI communications, function information is transmitted as a consumer electronics control (CEC) command, for example.

In the example of FIG. 7, for instance, individual function information is assigned so as to correspond to individual display positions, i.e., the respective display positions for the up, down, left, and right of the key image 71A (the cross key), the display position of the key image 71B (the select key), and the display position of the key image 71C (the “Back” key).

On the side of the television 3, the HDMI interface 31 receives the function information transmitted from the processing device 2, and the control unit 32 performs the control action that corresponds to the received function information. For example, when the function information that corresponds to the key image of the cross key is received, the item selection is moved in the menu screen that is displayed on the display unit 35, and when the function information that corresponds to the “Back” key is received, the previous screen is displayed on the display unit 35, and so forth.

After step S17, when the control unit 23 receives three-dimensional coordinate information in step S18 from the operating device 1 (Y in step S18), the procedure advances to step S20, and the control unit 23 determines whether or not the height position information it received has a value of 0. If the height position information has a value of 0 (Y in step S20), the procedure returns to step S18.

If the height position information has a positive value (Z>0) (N in step S20), however, the procedure advances to step S21, and the control unit 23 uses the coordinate information converting unit 23A to convert the two-dimensional coordinates received in step S18 into the coordinates of a display position on the display unit 35 and transmits the converted coordinate information and the hovering cursor image information over the HDMI interface 24 to the television 3. By doing this, the display on the display unit 35 is changed from a touch cursor to a hovering cursor on the side of the television 3. In this case, a hovering cursor is displayed at the position of the transmitted coordinate information.

After step S21, the procedure returns to step S13. Furthermore, if three-dimensional coordinate information is not received in step S18 (N in step S18), the procedure advances to step S19, and the control unit 23 cancels the display of the key images and touch cursor on the display unit 35 by transmitting a control signal over the HDMI interface 24 to the television 3. Then, the procedure returns to step S11.

The following provides a comprehensive explanation of the processing shown in FIGS. 5 and 6. When the user touches the touch panel 101 with a finger, the operating device 1 shifts into the hovering operation mode, and three-dimensional coordinate information that includes height position information having a positive value (Z>0) is output from the operating device 1 to the processing device 2 for as long as the virtual hovering operation (actually a touch operation on the touch panel surface) is being performed (step S3 of FIG. 5).

This causes the processing device 2 to display the key images and the hovering cursor in a superimposed manner on the television 3 (step S12 of FIG. 6) and subsequently to display the hovering cursor at a display position that corresponds to the two-dimensional coordinates (X, Y) received from the operating device 1 (step S16). That is, when a finger is moved over the touch panel surface as a virtual hovering operation, the hovering cursor is displayed moving correspondingly (in the example of FIG. 7, the hovering cursor 72 moves).

Then, when a particular operation is performed during the virtual hovering operation (such as stopping the finger movement), the operating device 1 outputs three-dimensional coordinate information that includes height position information with a value of 0 (Z=0) to the processing device 2, deeming a virtual touch operation to have been performed (step S6).

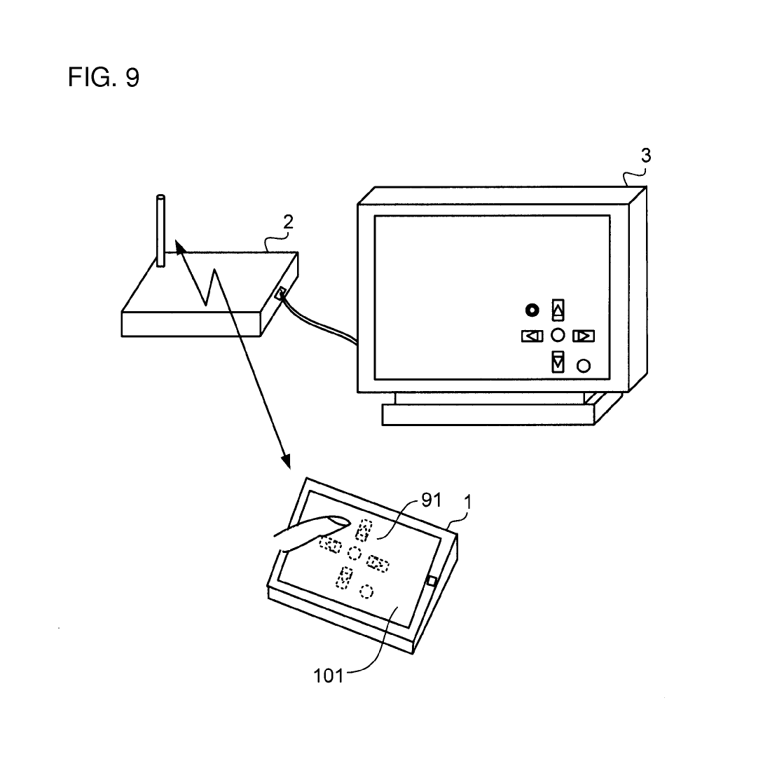

This causes the processing device 2 to change the display on the television 3 from the hovering cursor to a touch cursor while also outputting to the television 3 the function information of the key image that corresponds to the two-dimensional coordinate position at which the virtual touch operation was performed (step S17). If there is a virtual key at the position on the touch panel surface where the virtual touch operation was performed (to give one example, the virtual key 91 of FIG. 9), then the function information for this key is output. Accordingly, the television 3 performs a control action according to the function information.

Thus, with the present preferred embodiment, the user performs virtual hovering operations and virtual touch operations while viewing the key images of a remote control device displayed on the display screen 351 of the television 3 without looking at the touch panel 101 in hand, so an operating feel like that of conventional remote control devices can be obtained. That is, it is possible to realize a virtual touchscreen display with which the feel of operating using a conventional remote control device is obtained.

Moreover, when the touch is released (N in step S4) during a virtual hovering operation, the coordinate information generating unit 107 of the operating device 1 goes into standby (step S1), so the display of the key images and hovering cursor is canceled by the processing device 2 (step S14).

In addition, when the touch is released (N in step S4) after a virtual touch operation, the coordinate information generating unit 107 of the operating device 1 goes into standby (step S1), so the display of the key images and touch cursor is canceled by the processing device 2 (step S19).

Furthermore, when the operation shifts to a virtual hovering operation after a virtual touch operation (step S6, to Y in S4, to N in S5), display of the touch cursor is switched to display of a hovering cursor by the processing unit 2 (step S21).

### Second Preferred Embodiment

Next, a second preferred embodiment of the present invention will be described. Configurations that are fundamentally the same as in the first preferred embodiment described above (FIGS. 2 through 4) preferably are adopted for the operating device, processing device, and television according to the present preferred embodiment, for example.

However, in the present preferred embodiment, the coordinate information generating unit 107, the operating key 11, and the like are not necessary in the operating device 1; the touch panel 101 detects the three-dimensional position of an operating object such as a finger on the touch panel surface, and the detected three-dimensional coordinate information (X, Y, Z) is output to the processing device 2 via the wireless communication interface 109 and the antenna 110. When an operating object is positioned in the air above the touch panel surface of the touch panel 101, three-dimensional coordinate information that includes height position information having a positive value (Z>0) in keeping with the height position of the operating object is output; when the operating object is touching the touch panel surface, three-dimensional coordinate information that includes height position information with a value of 0 (Z=0) is output.

The control action of the processing device 2 according to the present preferred embodiment preferably is performed in the same way as in the flowchart shown in FIG. 6 described above, so it will be described below in tandem with the coordinate output processing of the operating device 1 according to the present preferred embodiment, along the lines of FIG. 6. Note that the description will be given with the operating object being a user's finger.

First, when the finger is brought to within the specified distance in the height direction from the touch panel surface of the touch panel 101, the touch panel 101 reacts, the touch panel 101 detects the three-dimensional position of the finger, and the three-dimensional coordinate information is output from the operating device 1 to the processing device 2. This causes the processing device 2 to receive the three-dimensional coordinate information (Y in step S11) and to display the key images and hovering cursor in a superimposed manner on the television 3 (step S12).

Then, three-dimensional coordinate information that includes height position information having a positive value (Z>0) is output from the operating device 1 to the processing device 2 for the duration of the operation with the finger in the air above the touch panel surface, that is, while an actual hovering operation is being performed. This causes the processing device 2 to display on the television 3 the hovering cursor at a position that corresponds to the received two-dimensional coordinate information (step S16).

Then, when the operation switches from the actual hovering operation to a touch operation on the touch panel surface (that is, when an actual touch operation is performed), three-dimensional coordinate information that includes height position information with a value of 0 (Z=0) is output from the operating device 1 to the processing device 2. This causes the processing device 2 to change the display on the television 3 from the hovering cursor to a touch cursor and to also output function information to the television 3 (step S17).

Thus, with the present preferred embodiment, the user obtains an operating feel like that of conventional remote control devices by performing actual hovering operations and actual touch operations while viewing the key images of a remote control device displayed on the display screen 351 of the television 3 without looking at the touch panel 101 in hand.

Note that, in the present preferred embodiment, because the touch panel surface preferably is not being viewed while the actual hovering operation is being performed, there may be cases in which the touch panel surface is touched unintentionally, thus ending up performing an actual touch operation. In this respect, more reliable operation is possible with a preferred embodiment in which a virtual touch operation is performed via a particular operation during a virtual hovering operation that involves operating the touch panel surface by an actual touch, as in the first preferred embodiment, and it is therefore desirable.

Moreover, in the present preferred embodiment, when the finger is moved away from the space above the touch panel surface during an actual hovering operation, the operating device 1 no longer outputs three-dimensional coordinate information, so the display of the key images and hovering cursor is canceled by the processing device 2 (step S14).

In addition, when the finger is moved away from the space above the touch panel surface after an actual touch operation, the operating device 1 no longer outputs three-dimensional coordinate information, so the display of the key images and touch cursor is canceled by the processing device 2 (step S19).

Furthermore, when the operation shifts to an actual hovering operation after an actual touch operation, the display of the touch cursor is switched to display of a hovering cursor by the processing device 2 (step S21).

### Other Modified Examples

For example, it is also possible to provide the operating device 1 with an acceleration sensor so as to detect inclination in the grip attitude of the operating device 1 or movement that accompanies inclination. In this case, the detection results are transmitted from the operating device 1 to the processing device 2, and on the side of the processing device 2, the display position of the key images on the television 3 is changed in accordance with the received detection results. By doing so, the user can change the display position of the key images by changing the inclination of the grip attitude on the operating device 1 or by moving the grip attitude at an inclination, thus preventing the key images from impeding visibility of underlying images.

Moreover, the display position of the key images may also be changed according to the two-dimensional position of an operating object such as a finger when the mode shifts to an hovering operation (the position touched on the touch panel surface in the case of the first preferred embodiment or the position where a finger or the like was brought closer to the touch panel surface in the case of the second preferred embodiment), for example. The display position of the key images is changed in step S12 according to the position of the two-dimensional coordinate information received in step S11 of FIG. 6. For instance, if the two-dimensional position is at the center, left side, or right side of the touch panel surface, then the key images are also correspondingly displayed at the center, left side, or right side of the screen. Consequently, the key images are displayed in the display position desired by the user, so it is possible to prevent the key images from impeding visibility of underlying images.

In addition, when it is determined on the side of the television 3 that the phase requires key input, for example (when a menu screen is displayed, for example), a control signal may be output from the television 3 to the processing device 2, and the control unit 23 of the processing device 2 may automatically shift into key input mode. The control unit 23 may, when it enters key input mode, enable the processing shown in FIG. 6, for example. Alternatively, the control unit 23 may display the key images on the television 3 when it shifts into the key input mode, and make it easier for the user to ascertain that it has entered key input mode.

Preferred embodiments of the present invention were described above, but a variety of modifications to the preferred embodiments are possible so long as they are within the scope of the spirit of the present invention.

For instance, in the preferred embodiments described above, function information preferably is output from the processing device 2, but it may also be output from the operating device 1 through the processing device 2. Specifically, in the case of the first preferred embodiment, the function information of the key that corresponds to the two-dimensional position touched when a particular operation (step S5 of FIG. 5) is performed may be output from the operating device 1. In the case of the second preferred embodiment, the function information of the key that corresponds to the two-dimensional position of a touch when an actual touch operation is performed may be output from the operating device 1.

Furthermore, a display unit that is integrated with the touch panel may be installed in the operating device, for example, and the key images may be displayed on the display unit. By doing so, the user can double check the key images displayed on the operating device as well as the television.

Moreover, the processing device and the television may also be configured as a singular television, for example. In addition, various preferred embodiments of the present invention can be applied not just to televisions but also to hard disc recorders, optical disc recorders, personal computers, and the like, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An operating system comprising:
a touch panel;
a coordinate information generating unit configured to, when a touch on the touch panel is detected, deem that a virtual hovering operation that is performed virtually in air above a touch panel surface of the touch panel was performed and shift to a hovering operation mode that generates two-dimensional coordinate information indicating a touched position on the touch panel and height position information having a positive value, and then, when a particular operation is received during the virtual hovering operation, deem that a virtual touch operation was performed and generate two-dimensional coordinates indicating the touched position on the touch panel and height position information having a value of zero;
a display control unit configured and programmed to display on a display unit a hovering cursor at a display position that corresponds to a two-dimensional position of the virtual hovering operation so as to be superimposed on key images for remote operation; and
a function information output unit configured to output, when the virtual touch operation is performed, function information assigned to a key that corresponds to the two-dimensional position of the virtual touch operation.

2. The operating system according to claim 1, wherein the display control unit is configured and programmed to change the display from the hovering cursor to a touch cursor when the virtual touch operation is performed.

3. The operating system according to claim 2, wherein the display control unit is configured and programmed to cancel the display of the key images and the touch cursor when the touch of the touch panel is released following the particular operation.

4. The operating system according to claim 1, wherein the display control unit is configured and programmed to cancel the display of the key images and the hovering cursor when the touch of the touch panel is released during the virtual hovering operation.

5. The operating system according to claim 1, wherein the particular operation is at least one of a touch operation that continues for a set period of time at a single position on the touch panel, a press operation on a specified operating key, a serial operation of a second touch after touch is released within a set period of time after the touch operation has continued at a single position on the touch panel, and a touch operation by an operating object that is different from that for the touch to enter the hovering operation mode.

6. The operating system according to claim 1, further comprising an operating device including the touch panel and a detecting unit configured to detect an inclination of the grip attitude of the operating device or movement that accompanies the inclination, and the display control unit is configured and programmed to change the display position of the key images according to detection results from the detecting unit.

7. The operating system according to claim 1, wherein the display control unit is configured and programmed to change the display position of the key images according to the two-dimensional position of the operating object on the touch panel surface when the mode shifts to the hovering operation.

8. The operating system according to claim 1, further comprising a judgment unit configured to make a judgment that a phase that requires key input has been entered, and to automatically shift into a key input mode which enables superimposed display control of the key images and the hovering cursor when there is a judgment by the judgment unit.

9. An operating system comprising:
a touch panel;
a display control unit configured and programmed to display on a display unit a hovering cursor at a display position that corresponds to a two-dimensional position of a hovering operation that is performed actually in air above a touch panel surface of the touch panel so as to be superimposed on key images for remote operation; and
a function information output unit configured to output, when the hovering operation is switched to a touch operation that touches the touch panel, function information for a key that corresponds to the two-dimensional position of the touch operation.

10. The operating system according to claim 9, further comprising an operating device including the touch panel and a detecting unit configured to detect an inclination of the grip attitude of the operating device or movement that accompanies the inclination, and the display control unit is configured and programmed to change the display position of the key images according to detection results from the detecting unit.

11. The operating system according to claim 9, wherein the display control unit is configured and programmed to change the display position of the key images according to the two-dimensional position of the operating object on the touch panel surface when the mode shifts to the hovering operation.

12. The operating system according to claim 9, further comprising a judgment unit configured to make a judgment that a phase that requires key input has been entered, and to automatically shift into a key input mode which enables superimposed display control of the key images and the hovering cursor when there is a judgment by the judgment unit.

13. The operating system according to claim 9, wherein the display control unit is configured and programmed to change the display from the hovering cursor to a touch cursor when a virtual touch operation is performed.

14. The operating system according to claim 13, wherein the display control unit is configured and programmed to cancel the display of the key images and the touch cursor when the touch of the touch panel is released following a particular operation.

15. The operating system according to claim 9, wherein the display control unit is configured and programmed to cancel the display of the key images and the hovering cursor when the touch of the touch panel is released during a virtual hovering operation.

16. The operating system according to claim 14, wherein the particular operation is at least one of a touch operation that continues for a set period of time at a single position on the touch panel, a press operation on a specified operating key, a serial operation of a second touch after touch is released within a set period of time after the touch operation has continued at a single position on the touch panel, and a touch operation by an operating object that is different from that for the touch to enter the hovering operation mode.
